(19) United States
(12) Patent Application Publication
(10) Pub. No.: US 2005/0013141 A1
(43) Pub. Date: Jan. 20, 2005

(54) Method and system for independently displaying a plurality of visual signals

(76) Inventors: Ricardo Ernesto Espinoza-Ibarra, Lincoln, CA (US); Sachin Navin Chheda, Roseville, CA (US); Robert William Dobbs, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/623,015

(22) Filed: Jul. 17, 2003

(51) Int. Cl. F21V 7/04

(52) U.S. Cl. 362/551; 362/583

(57) ABSTRACT

In one embodiment, the present invention recites a lightpipe having a major axis, a first end, and a second end. A light emitting feature having a defined surface is located along the length of the lightpipe. The light emitting feature is adapted to transmit electromagnetic energy of a specific visible wavelength of light from inside the lightpipe to outside the lightpipe.

### TECHNICAL FIELD

Embodiments of the present invention relate to a multi-function visual display using a lightpipe.

### BACKGROUND ART

With space and power at an ever-increasing premium in most electronic equipments, the use of multiple light-emitting diodes (LEDs) or other visual signal generating sources has a component cost and a cabling expense, in addition to an increased power consumption factor. Increased power consumption also means higher air-conditioning costs. Therefore, reducing the number of redundant display elements is a desirable design goal from both an equipment cost and an operating cost standpoint.

Lightpipes are used to convey a visual signal indicating a status condition or information encoded on a light source from a source of light. Referring to FIG. 1, a basic lightpipe 10 is shown, with its principal axis 11 depicted, representing the prior art. Lightpipes are typically made from a plastic material and are axially uniform and circular in cross section, but could be made with any desired cross section.

Typically there is only one output available at the end of the lightpipe opposite the light source. Often, the status condition being indicated by the on/off condition of the LED needs to be displayed at multiple locations on an item of equipment. For example, whether the item of equipment is turned on and is running is often displayed on the front panel, but could also be very useful at the rear of the equipment as well, particularly in equipments that are rack-mounted, where it is inconvenient to see the front panel from behind the rack. Thus, there is a need for a display system that minimizes the use of operating power, provides for multiple display locations, and increases the number of status conditions that can be displayed at a given location.

### SUMMARY OF THE INVENTION

In one embodiment, the present invention recites a lightpipe having a major axis, a first end, and a second end. A light emitting feature having a defined surface is located along the length of the lightpipe. The light emitting feature is adapted to transmit electromagnetic energy of a specific visible wavelength of light from inside the lightpipe to outside the lightpipe.

### BRIEF DESCRIPTION OF THE DRAWINGS

The accompanying drawings, which are incorporated in and form a part of this specification, illustrate embodiments of the invention and, together with the description, serve to explain the principles of the invention. The drawings referred to in this description should be understood as not being drawn to scale except if specifically noted.

FIG. 1 shows a prior art lightpipe with a major axis at the center of the cylindrical cross section of the pipe.

FIG. 2 shows a pair of light emitting diodes (LEDs) mounted at either end of a light pipe and a light emitting feature for radiating the light from either of the two LEDs in accordance with embodiments of the present invention.

FIG. 3A is a top view of a lightpipe in accordance with embodiments of the present invention in which a light emitting feature is created by removing a wedge-shaped element of the lightpipe.

FIG. 3B is a front view of a lightpipe in accordance with embodiments of the present invention in which a light emitting feature is created by removing a wedge-shaped element of the lightpipe.

FIG. 4A is a top view of a lightpipe in accordance with embodiments of the present invention in which a light emitting feature is created by removal of a spherical element of the lightpipe.

FIG. 4B is a front view of a lightpipe in accordance with embodiments of the present invention in which a light emitting feature is created by removal of a spherical element of the lightpipe.

FIG. 5A is a top view of a lightpipe in accordance with embodiments of the present invention in which a light emitting feature is created by removal of a stepped element of the lightpipe.

FIG. 5B is a front view of a lightpipe in accordance with embodiments of the present invention in which a light emitting feature is created by removal of a stepped element of the lightpipe.

FIG. 6 is a top view of a lightpipe in accordance with embodiments of the present invention in which a light emitting feature is created by forming a spherical protrusion on the surface of the lightpipe.

FIG. 7A is a top view of a lightpipe with a light emitting feature having two faces, each of which is lined with a polarizing element and capped by an optional lens in accordance with embodiments of the present invention.

FIG. 7B is a front view of the light pipe of FIG. 7A with the polarizing elements and the lens shown removed from the light emitting feature of the light pipe.

FIG. 7C is a top view of the lightpipe of FIG. 7A with the polarizing elements and the optional lens shown removed from the lightpipe.

FIG. 7D shows two polarizing filter elements with their transmission polarization orientations depicted in accordance with embodiments of the present invention.

FIG. 8 is a light-emitting diode (LED) assembly with a LED, polarizing element and mounting assembly in accordance with embodiments of the present invention.

FIG. 9 is a flowchart of a method for reducing the effects of destructive interference in a lightpipe in accordance with embodiments of the present invention.

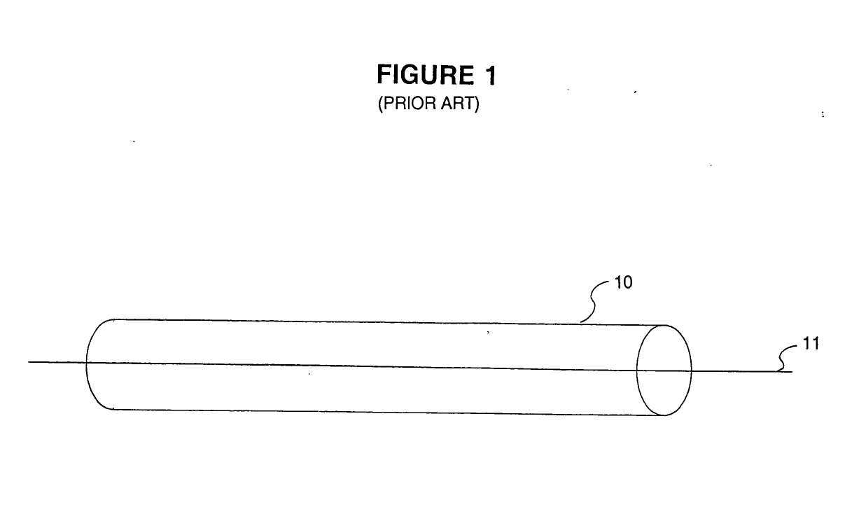

### BEST MODE FOR CARRYING OUT THE INVENTION

Reference will now be made in detail to the preferred embodiments of the invention. While the invention will be described in conjunction with the preferred embodiments, it will be understood that they are not intended to limit the invention to these embodiments. On the contrary, the invention is intended to cover alternatives, modifications and equivalents as defined by the appended claims. Furthermore, in the following detailed description of the present invention, numerous specific details are set forth in order to provide a thorough understanding of the present invention. However, it will be recognized by one skilled in the art that the present invention may be practiced without these specific details. In other instances, well known methods, procedures, components, and circuits have not been described in detail as to avoid unnecessarily obscuring aspects of the present invention.

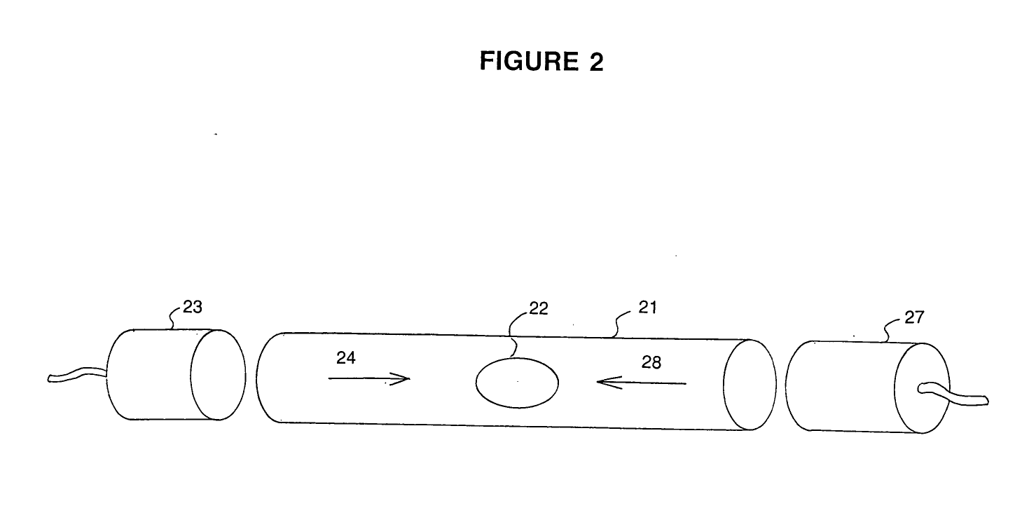

FIG. 2 shows an embodiment of the present invention, which consists of a lightpipe 21, a port 22 for intercepting and directing any light passing through the lightpipe, as depicted by arrows 24 and 28, to the outside of the lightpipe. Port 22 lets light out of lightpipe 21 at whatever point on lightpipe 21 at which port 22 is located. Light ordinarily does not escape to any significant degree from the lightpipe because of internal reflection. However, by removing a portion of lightpipe 21 at port 22, the angle of incidence of the light at the face(s) on port 22 now exceeds the limit for internal reflection, and light can pass through the port 22. In another embodiment of the present invention, port 22 comprises a protuberance on lightpipe 21. The angle of incidence of the light at the face of the protuberance exceeds the limit for internal reflection, and light can pass through the port. In embodiments of the present invention, the light is created by the light emitting-diodes (LEDs) 23 and 27. The light passes along the lightpipe in the two directions of travel as depicted by arrows 24 and 28, where each light beam is incident on the faces of the port 22 which intrude into lightpipe 21 some distance, as well as continuing to travel the remainder of the length of lightpipe 21. Although LEDs are recited in the present embodiment, the lightpipe of the present invention is well suited to use various other light sources.

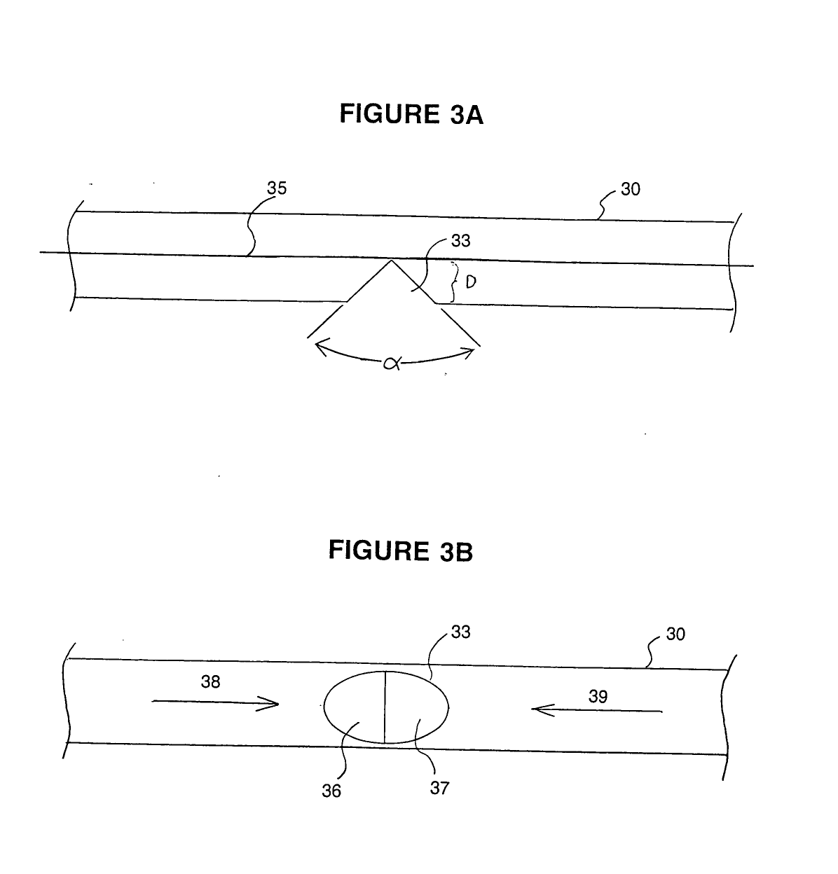

With reference now to FIG. 3A, a top view of a lightpipe 30 is depicted with a port created by removing a wedge shaped portion 33 of lightpipe 30. Section 33 is described by an angle α, which in the present embodiment is a 90-degree angle, and a depth D. Although such an angle is shown in the present embodiment, the present invention is well suited to adjusting this angle to suit the display design requirements, but is typically not greater than 150 degrees, otherwise internal reflection will be in effect and little light will escape. In the embodiment of FIG. 3A, the intersection of the two planes occurs at the major axis 35 of the light pipe as shown in FIG. 3A. Thus the depth of section 33 forming the port is one half the diameter of lightpipe 30. In various embodiments of the present invention, this depth is adjustable depending on the number of display points, the size of the desired port, the degree of brightness desired, and the relative strength of the lightpipe. In one embodiment, the depth is less than half the diameter of the lightpipe.

Referring now to FIG. 3B, the front view of the port created by the removal of the wedge-shaped portion 33 is shown. In FIG. 3B, the two planes (e.g., plane 36 and plane 37) forming the angle α are visible. Light, represented by arrows 38 and 39, travels along the major axis of lightpipe 30 and does not escape due to internal reflection. However, when light strikes planes 36 and 37, the angle of internal reflection is exceeded and light can escape lightpipe 30 on the faces of planes 38 and 39.

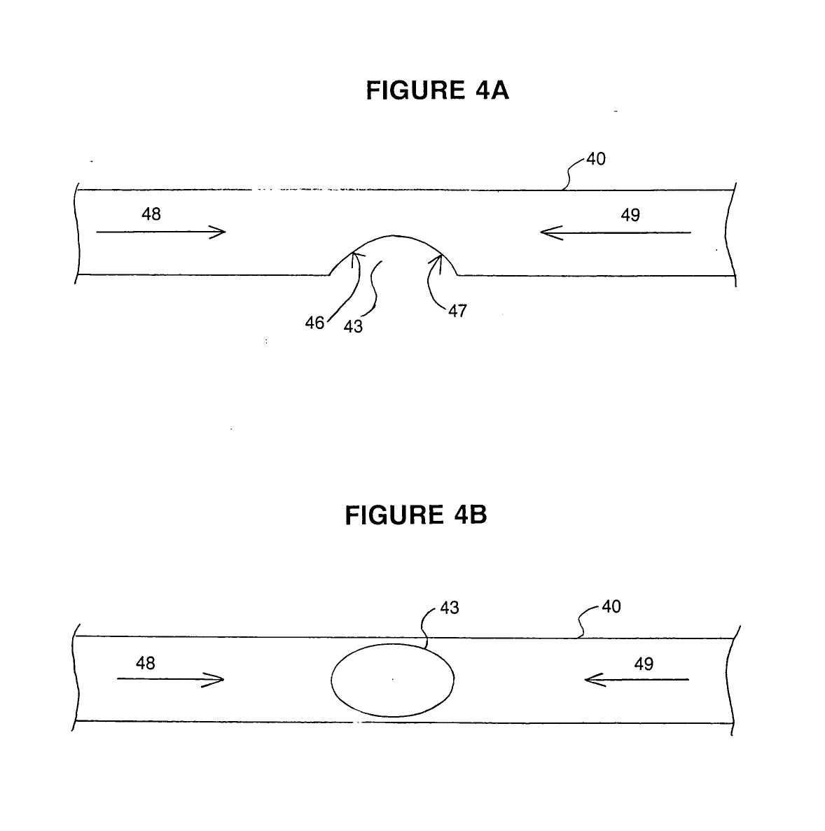

Referring now to FIG. 4A, a top view of the lightpipe 40 is shown depicting a port 43 created by the removal of a semi-spherical portion of lightpipe 40. This represents any of a number of other shapes that can be used to create port 43. FIG. 4B shows a front view of lightpipe 40 and depicts the port 43 as created by the removal of the semi-spherical shape. Light incident from the left side of lightpipe 40 as depicted by arrow 48 will escape through the left side of port 43 at the location depicted by arrow 46, and light incident from the right side of lightpipe 40 as depicted by arrow 49 will escape from the right side of port 43 at the location depicted by arrow 47. Other arbitrary shapes can also be used as the section that is removed to create port 43 in embodiments of the present invention. Generally, much of the surface of the notch created by the void should have an angle relative to the lightpipe axis or edge of the lightpipe that is greater than the angle for total internal reflection.

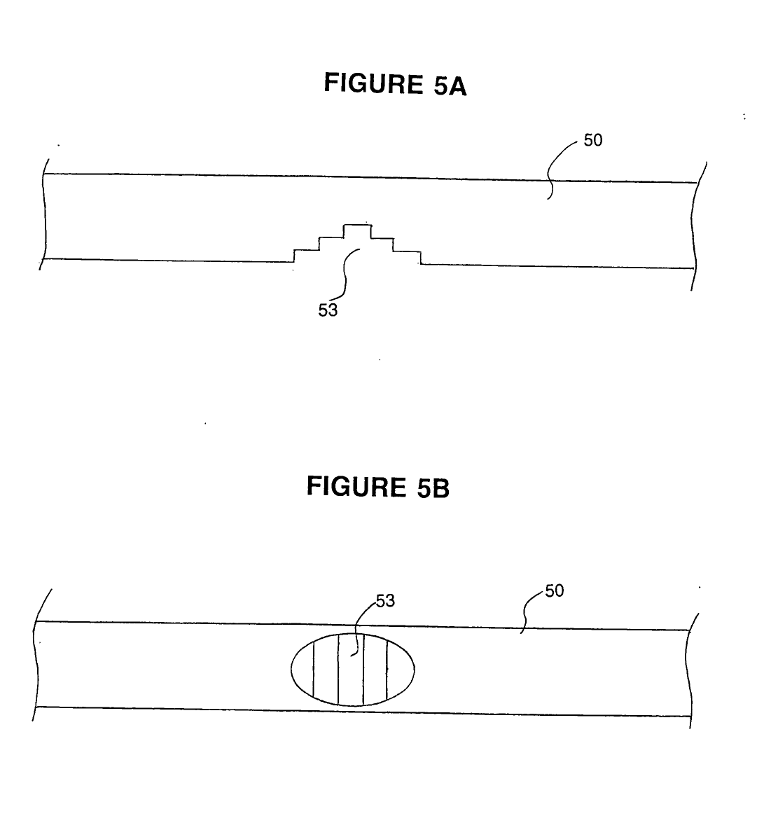

Referring now to FIG. 5A, a top view of a lightpipe 50 is shown in which a port 53 is created by removal of a stepped element of the lightpipe. Again, this is representative of a variety of shapes that can be used to create a port in a lightpipe in accordance with embodiments of the present invention. Light travelling down the major axis of lightpipe 50 hits the stepped surfaces of port 53 and can escape from lightpipe 50. FIG. 5B is a front view of lightpipe 50 showing the port 53 created when a stepped element is removed from the lightpipe.

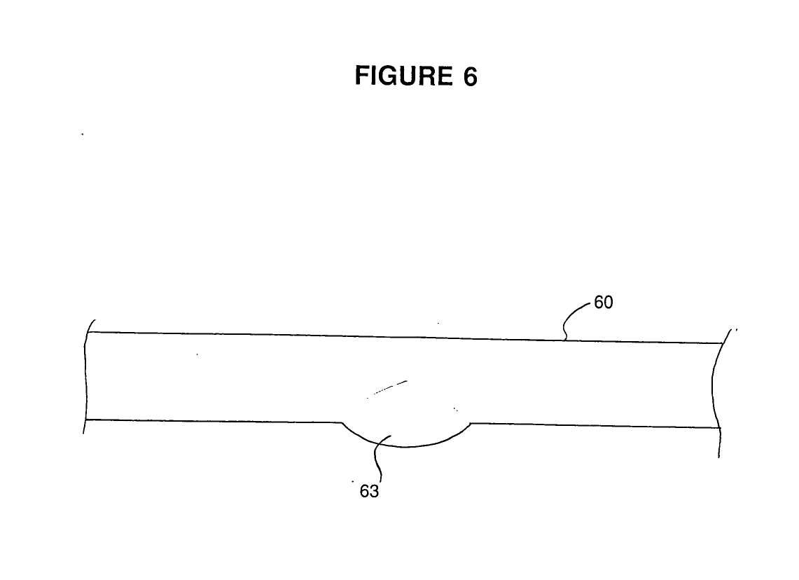

FIG. 6 is a top view of a lightpipe in accordance with embodiments of the present invention in which a light emitting feature is created by forming a spherical protrusion 63 on the surface of lightpipe 60. Protrusion 63 may be formed upon the surface of lightpipe 60 when lightpipe 60 is fabricated in embodiments of the present invention. Alternatively, protrusion 63 may be glued to lightpipe 60. For example, a portion of lightpipe 60 may be removed and protrusion 63 glued into the void created when the portion was removed.

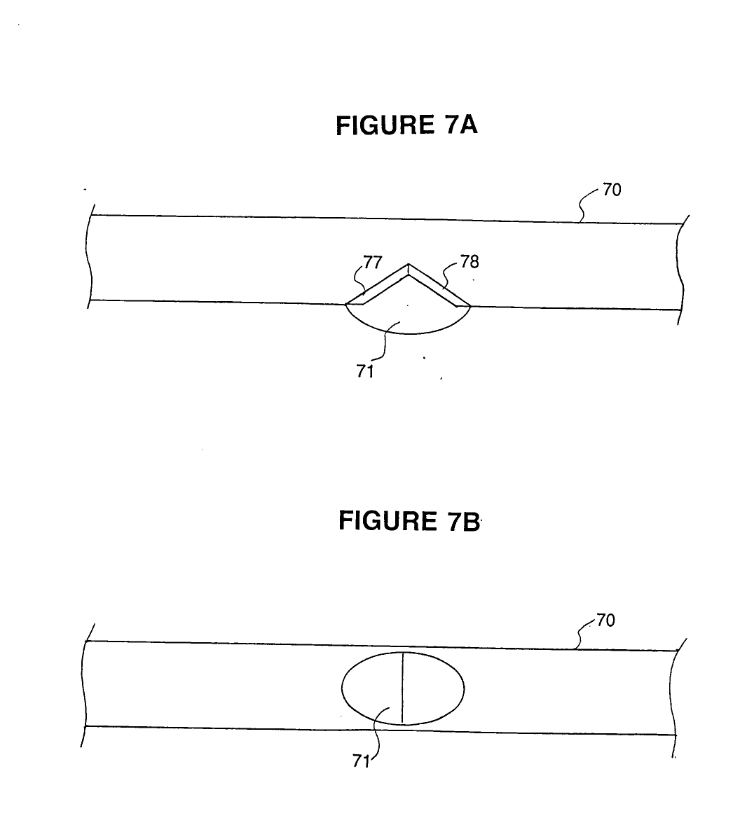

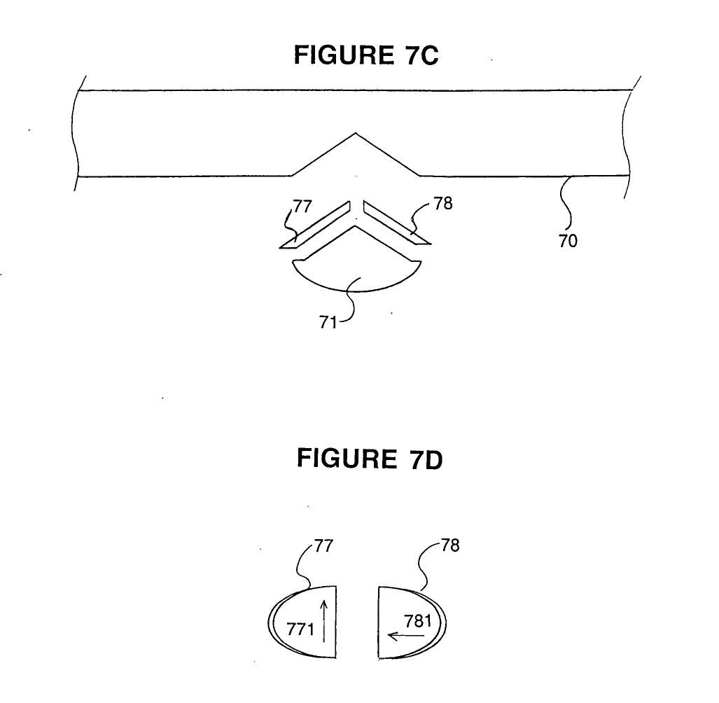

FIG. 7A shows a top view of a lightpipe 70 with a port depicted having a lens 71 filling the void created by the removal of lightpipe material. The lens 71 is further displayed in the top view of FIG. 7C. In embodiments of the present invention, the lens 71 can be affixed to the port with glue or another suitable fastening method. The lens 71 can be designed to fit the void in lightpipe 70 exactly, and be installed entirely by itself, or it can be installed over two polarization filter elements 77 and 78 as shown in FIGS. 7A and 7C. The filter elements 77 and 78 are further depicted in FIG. 7D, where the relative angle of polarization, as depicted by arrows 771 and 781, is shown for each element. Element 78 is shown to be horizontally polarized, and element 77 is shown to be vertically polarized. Alternatively, the two polarization filter elements 77 and 78 can be affixed to the lens 71 and then the entire assembly can be fitted into the void created in lightpipe 70. In embodiments of the present invention, these polarization filter elements can work with similar polarization filter elements located at the source(s) of light, such as the LED assemblies 23 and 27 of FIG. 2.

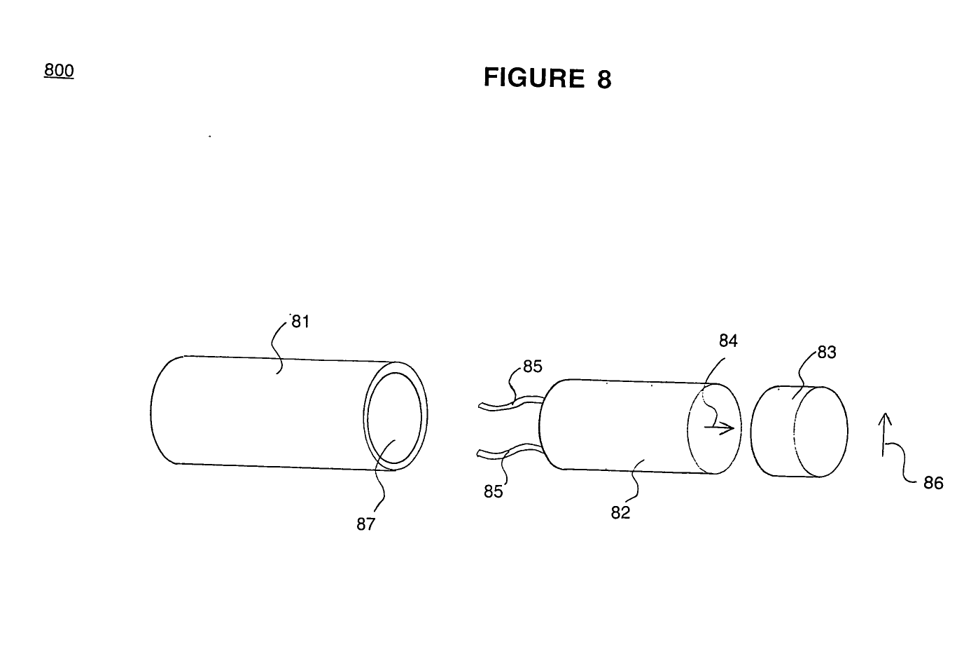

FIG. 8 shows an LED assembly 800 used in embodiments of the present invention. It is appreciated that the description of LED assembly 800 is exemplary and that features recited in the description of assembly 800 may be omitted, or additional elements may be included in other embodiments of the present invention. An LED 82 and its power wires 85 are mounted in a housing 81, along with the polarizing filter element 83. Light, as depicted by arrow 84, light from LED 82 passes through polarizing filter element 83 and emerges vertically polarized, as shown by the vector arrow 86. The diameter of the aperture 87 of the housing 81 can be made just large enough to slip over the end of a lightpipe (e.g., lightpipe 21 of FIG. 2) and can be rotated to achieve the desired polarization alignment with respect to another LED assembly (e.g., LED assembly 27 of FIG. 2).

In embodiments of the present invention, the LED assemblies can be fixed in place with glue, a compressive mounting ring, or other suitable mounting methods. These assemblies are merely representative of one way of joining and aligning an LED and polarization filter, and affixing the entire assembly to a lightpipe. It is appreciated that other methods for joining and aligning an LED and polarization filter may be used in embodiments of the present invention.

These polarizing filter elements reduce, if not eliminate, the likelihood that any light from the opposite polarization will get through and give a false indication on that side of the port. Referring again to FIG. 3B, the light depicted by arrow 39 of FIG. 3B, is polarized horizontally and hits on the right face 37 of FIG. 3B, to which has been affixed a polarization filter element (e.g., polarization filter 78 of FIGS. 7A, 7C, and 7D). The light then passes through polarization filter 78 to either a lens (e.g., lens 71 of FIGS. 7A and 7C) or to the outside of the lightpipe 30. Some of the light energy continues past the vertex of the port, and through internal reflection some of its energy may be directed toward the left face 36 of the port 33. A polarization filter element (e.g., polarization filter 77 of FIGS. 7A, 7C, and 7D), affixed on face 36, is oriented so that its polarization angle of transmission is orthogonal to the polarization of light 39, and so very little of light 39 gets through the polarization filter to the outside of the lightpipe 30. The polarization filters of the LED assemblies (e.g., LED assemblies 23 and 27 of FIG. 2) can be oriented so that the polarization angle of one LED assembly (e.g., LED assembly 23 of FIG. 2) is made orthogonal to the polarization angle of the other LED assembly (e.g., LED assembly 27 of FIG. 2). This reduces the likelihood of destructive interference reducing the amplitude of the light available at a given face of port 33, for each color of light, and for any location of the port along the length of the lightpipe.

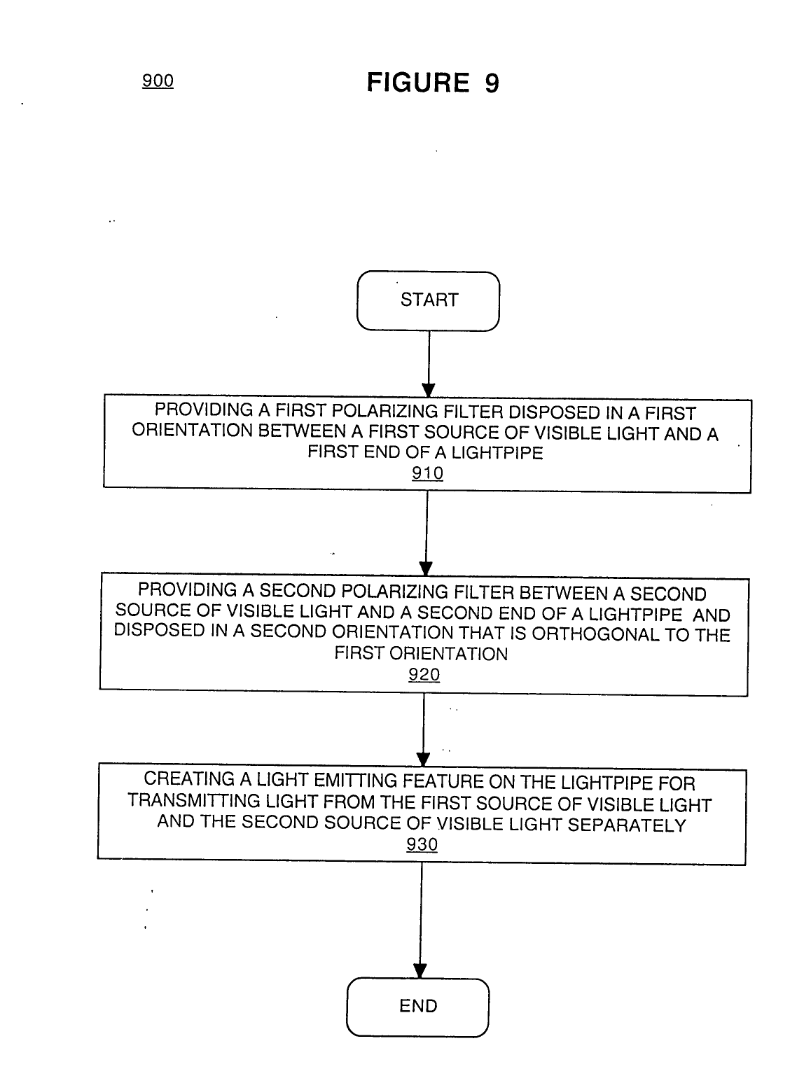

FIG. 9 is a flowchart of a method 900 for reducing the effects of destructive interference in a lightpipe in accordance with embodiments of the present invention. For purposes of clarity, the following discussion will refer to FIG. 2, FIG. 7A, and FIG. 8 to more clearly describe the present invention. In step 910 of FIG. 9, a first polarizing filter is provided between a first source of visible light and a first end of a lightpipe and is disposed in a first orientation. Referring now to FIG. 2, a first source of visible light (e.g., LED assembly 23 of FIG. 2) is located at a first end of lightpipe 21. Light, represented by arrow 24, from LED assembly 23 is polarized vertically due to the vertical orientation of a polarizing filter (e.g., polarizing filter element 83 of FIG. 8) that is disposed between an LED of assembly 23 and the end of lightpipe 21.

In step 920 of FIG. 9, a second polarizing filter is provided between a second source of visible light and a second end of the lightpipe, and is disposed in a second orientation that is orthogonal to the first orientation. Referring again to FIG. 2, a second source of visible light (e.g., LED assembly 27 of FIG. 2) is located at a second end of lightpipe 21. Light, represented by arrow 28 is polarized horizontally due to the horizontal orientation of a polarizing filter (e.g., polarizing filter element 83 of FIG. 8) that is disposed between an LED of assembly 27 and the end of lightpipe 21.

In step 930 of FIG. 9, creating a light emitting feature is created on the lightpipe for transmitting light from said first source of visible light and light from said second source of visible light separately. Referring again to FIG. 2, a light emitting feature (e.g., port 22 of FIG. 2) is created for transmitting light outside of lightpipe 21. Referring now to FIG. 7A, polarization filter elements 77 and 78 are for selectively filtering light such that light from LED assembly 23 can pass through polarization filter element 77 and can be transmitted outside of the lightpipe via lens 71. As described above, polarization filter element 77 can be oriented so that only light that is vertically polarized can pass through. Additionally, light from LED assembly 27 can pass through polarization filter element 78 and can be transmitted outside of the lightpipe via lens 71. As described above, polarization filter element 78 can be oriented so that only light that is horizontally polarized can pass through. As a result, vertically polarized light from LED assembly 23 cannot pass through polarization filter element 78 and light from LED assembly 27 cannot pass through polarization filter element 77. This prevents destructive interference from the separate light sources from occurring in port 22.

Various embodiments of the present invention, a method and system for displaying a plurality of visual signals, are thus described. While the present invention has been described in particular embodiments, it should be appreciated that the present invention should not be construed as limited by such embodiments, but rather construed according to the following claims.

1. A light pipe comprising:
a lightpipe having a major axis and a first end and a second end;
a light emitting feature having a defined surface located along the length of said lightpipe, wherein said light emitting feature is adapted to transmit electromagnetic energy of a specific visible wavelength of light from inside said lightpipe to outside of said lightpipe.

2. The lightpipe of claim 1, wherein said light emitting feature is disposed on the surface of said lightpipe.

3. The lightpipe of claim 1, wherein said light emitting feature comprises a void in said lightpipe, said void comprising the absence of a portion of the lightpipe.

4. The lightpipe of claim 3, wherein said void has a cross section and a depth.

5. The lightpipe of claim 4, wherein said cross section of said void is cylindrical.

6. The lightpipe of claim 4, wherein said cross section of said void is semi-spherical.

7. The lightpipe of claim 4, wherein said cross section is an angle formed by two planes meeting at an apex forming a line, wherein said angle apex line is perpendicular to said major axis of said lightpipe.

8. The lightpipe of claim 1, wherein at least a portion of said defined external surface of said light emitting feature is adapted to receive a wavelength specific transmissive filter element.

9. The lightpipe of claim 1, wherein light of a specific visible wavelength is obtained from a laser diode adapted to radiate a substantial portion of said light into either of said first and second end of said lightpipe.

10. The lightpipe of claim 1, wherein said lightpipe is configured to receive light of a first specific visible wavelength from a first light source into said first end of said lightpipe, and light of a second specific visible wavelength from a second light source into said second end of said lightpipe.

11. A display system, comprising:
a lightpipe with a first end and a second end;
a first source of controllable visible light coupled to said first end of said lightpipe and a second source of controllable visible light coupled to said second end of said lightpipe;
a light emitting feature located along said lightpipe, said light emitting feature adapted to display light from said first source of controllable visible light and to display light from said second source of controllable visible light.

12. The display system of claim 11, further comprising:
a first polarization element disposed between said first source of controllable visible light; and
a second polarization element disposed between said second source of controllable visible light.

13. The display system of claim 12 wherein the alignment of said first polarization element is orthogonal to the alignment of said second polarization element.

14. The lightpipe of claim 11, wherein said light emitting feature is disposed on the surface of said lightpipe.

15. The lightpipe of claim 11, wherein said light emitting feature comprises a void in said lightpipe, said void comprising the absence of a portion of the lightpipe.

16. The lightpipe of claim 11, wherein said light emitting feature further comprises:
at least one polarizing element disposed upon a surface of said light emitting feature.

17. A method for reducing the effects of destructive interference in a lightpipe comprising:
providing a first polarizing filter between a first source of visible light and a first end of the lightpipe and disposed in a first orientation;
providing a second polarizing filter between a second source of visible light and a second end of the lightpipe, and disposed in a second orientation that is orthogonal to said first orientation; and
creating a light emitting feature on the lightpipe for transmitting light from said first source of visible light and light from said second source of visible light separately.

18. The method as recited in claim 17, wherein said creating said light emitting feature comprises removing a portion of the lightpipe.

19. The method as recited in claim 18 further comprising:
orienting a third polarizing filter that is disposed upon a first surface of said light emitting feature and oriented to pass light from said first source of visible light; and
orienting a fourth polarizing filter that is disposed upon a second surface of said light emitting feature and oriented to pass light from said second source of visible light.

20. The method as recited in claim 17, wherein said light emitting feature is disposed upon the surface of the lightpipe.
